(19) United States
(12) Patent Application Publication
(10) Pub. No.: US 2013/0112286 A1
(43) Pub. Date: May 9, 2013

(54) QUICK-CONNECT COUPLING

(71) Applicants: FERN KIROUAC, CLARENCE CREEK (CA); CLAUDE LONGPRE, Gatineau (CA)

(72) Inventors: FERN KIROUAC, CLARENCE CREEK (CA); CLAUDE LONGPRE, Gatineau (CA)

(21) Appl. No.: 13/458,736

(22) Filed: Apr. 27, 2012

Related U.S. Application Data
(60) Provisional application No. 61/480,628, filed on Apr. 29, 2011.

(51) Int. Cl. F16K 1/32

(52) U.S. Cl. CPC F16K 1/32
USPC 137/315.01

(57) ABSTRACT

A quick connect coupler for applications transmitting compressed fluid is disclosed, having a poppet valve mounted within a body. A body cap may be detachably threaded to the body, putting the poppet valve into an airflow position. The poppet valve is movable from a sealing position where it sits against a seat and O-ring, preventing the passage of compressed fluid through the valve, to an airflow position that permits air to flow through the valve. The poppet valve is biased to the sealing position by a spring, and in the airflow position the poppet is pushed away from the seat by a plunger mounted within the body cap. The poppet valve has a core and a head, and the core has at least one aperture therein for the passage of compressed fluids, and the head has at least one indentation corresponding to the aperture. The invention may be used for paintball with a described coiled air hose.

This application claims priority to U.S. Provisional Patent Application No. 61/480,628, filed Apr. 29, 2011, which is incorporated herein by reference in its entirety.

### FIELD

This disclosure relates to a coupler assembly and, in particular, a coupler assembly for providing fluid from a compressed fluid source.

### BACKGROUND

Paintball has been popular for over two decades. Teams of opposing players shoot paint-filled, gelatin paintballs at each other using a gas-powered paintball marker, or paintball gun, which is trigger-activated.

Paintball markers are typically powered using compressed gas bottles, typically containing CO.sub.2 or air, wherein the pressure ranges from 1800 psi to 4500 psi. Those gas bottles are sometimes placed in a backpack worn by the player and connected to the paintball marker using a remote gas line.

During play, a player may want to switch his gas bottle for a gas bottle containing a different gas or the same gas stored at a different pressure. This allows the player to give different effects and trajectories to paintballs fired from his paintball marker. As the gas bottle has a limited capacity, the player may also want to refill his gas bottle to raise the pressure provided to the marker. The player may further want to perform maintenance operations on his paintball marker, such as cleaning paintball debris out of the barrel of the paintball marker.

All of the operations previously mentioned involve the disconnection of the gas bottle from the paintball marker. This operation can be hazardous and must be conducted with extreme care. Due to the high pressure present in the gas bottle, a gas bottle disconnected quickly from a paintball marker may be propelled through the air in a missile-like fashion by the pressure from the compressed fluid flowing freely from the gas bottle, potentially damaging structures and causing bodily harm to players or bystanders.

It will also be appreciated that when a paintball marker is connected to gas bottle, the compressed fluid flowing into the paintball marker will cause a build-up of pressure inside the paintball marker. A paintball may thus still be accidentally fired from the paintball marker even after the gas bottle has been disconnected.

Therefore, prior to the disconnection, the pressure of compressed gas built up inside the paintball marker must be relieved. Currently, paintball players are first closing the compressed gas input from the gas bottle, and then activating the trigger of the paintball marker without any paintball loaded. Each trigger activation lets out a small amount of pressure, until the pressure inside the paintball marker is equal to atmospheric pressure.

The player can then safely unhook the gas bottle from the paintball marker. It will be appreciated that this task is cumbersome and time consuming, and may not be undertaken during paintball games where the play time is limited or key.

During this whole process, the player is also prevented from using his paintball marker, which renders that situation highly undesirable during play.

Previous attempts have been made at solving this problem, namely the inclusion of a coupler between the paintball marker and gas bottle. Examples of such couplers can be found in U.S. Pat. No. 6,260,821, U.S. Pat. No. 6,722,391, U.S. Pat. No. 6,941,938, US Patent Publication 2006/0032647 and US Patent Publication 2010/0031943. These references do not address all of the above-identified problems, either because they do not allow the player to relieve pressure from the paintball marker at all or because they do not allow quick relief of pressure from the paintball marker.

There is therefore a need for a device that will overcome at least one of the above identified drawbacks, for paintball or any compressed fluid quick-connect application. In particular, there is a need for a device that enables connecting and disconnecting under pressure, that is secure in its attachment and reduces accidental disconnection, and that permits a high flow of a fluid such as air through the line and valve.

Features of the invention will be apparent from review of the disclosure, drawings and description of the invention below.

### SUMMARY

A quick connect coupler for the passage of pressurized fluids is disclosed, comprising a body having threading, the body having an air passage therethrough, a body cap having a threaded inner diameter, a poppet movable from a downstream sealing position to an upstream airflow position, the poppet valve biased to the sealing position by a spring, the poppet valve having a core and a head, the core having at least one aperture therein for the passage of fluids from an upstream to a downstream direction and the head having at least one indentation corresponding in number and position with the at least one aperture; and a plunger having a tip for contacting the head of said poppet wherein the body and body cap are adapted to be sealingly threaded together, the poppet valve is positioned within the body and the plunger is positioned within the body cap.

### BRIEF DESCRIPTION OF THE DRAWINGS

The invention both as to its organization and method of operation, together with further aspects and advantages thereof, may be best understood by reference to the accompanying drawings and text thereof in light of the brief description therefore.

FIG. 1 is a view of the assembled coupling;

FIG. 2 is a disassembled view of the coupling, showing two views of each of the body and the body cap;

FIG. 3 is a side cut-away view of the quick-connect coupling;

FIG. 4a is a front perspective view of the poppet;

FIG. 4b is a rear perspective view of the poppet;

FIG. 5 is a side view of the poppet;

FIG. 6a is front perspective view of the plunger;

FIG. 6b is rear perspective view of the plunger;

FIG. 7 is a side cut-away view of the quick-connect coupling, as the threading is not yet started;

FIG. 8 is a side cut-away view of the quick-connect coupling, as the coupling is partially threaded;

FIG. 9 is a side cut-away view of the quick-connect coupling, as the coupling is fully mated; and

FIG. 10 is a side-view of the fully-open poppet valve, showing the flow of air;

FIG. 11 is a perspective view of an air hose to be used with the quick-connect coupling of the present invention; and

FIG. 12 is a perspective view of an air hose having a quick-connect coupling attached to the air hose.

### DETAILED DESCRIPTION OF THE PREFERRED EMBODIMENTS

The present invention will now be described more fully hereinafter with reference to the accompanying drawings, in which preferred embodiments of the present invention are shown. This invention may however, be embodied in many different forms and should not be construed as limited to the embodiments set forth herein. Rather, these embodiments are provided so that this application will be thorough in illustrations and brief explanation therefore to convey the true scope of the invention to those skilled in the art. Some illustrations provided herein include detailed explanations of dimension and operation and as such should be not be limited thereto.

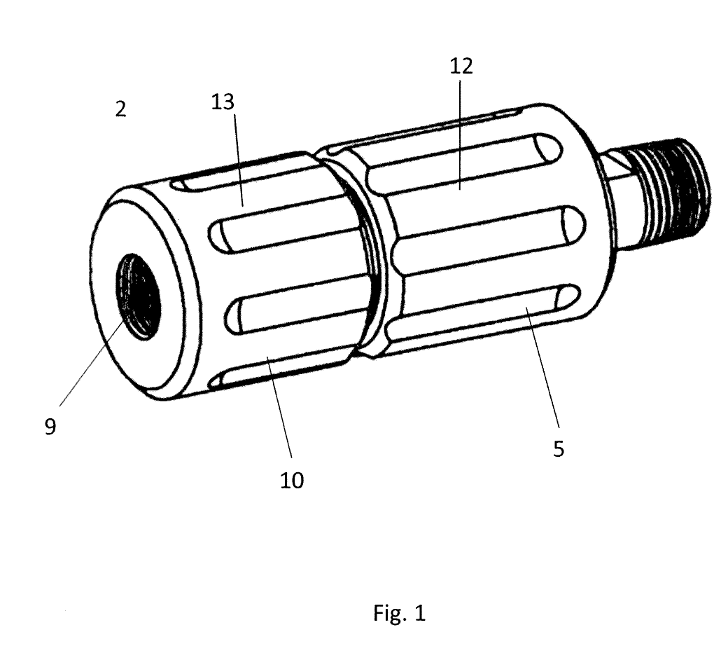

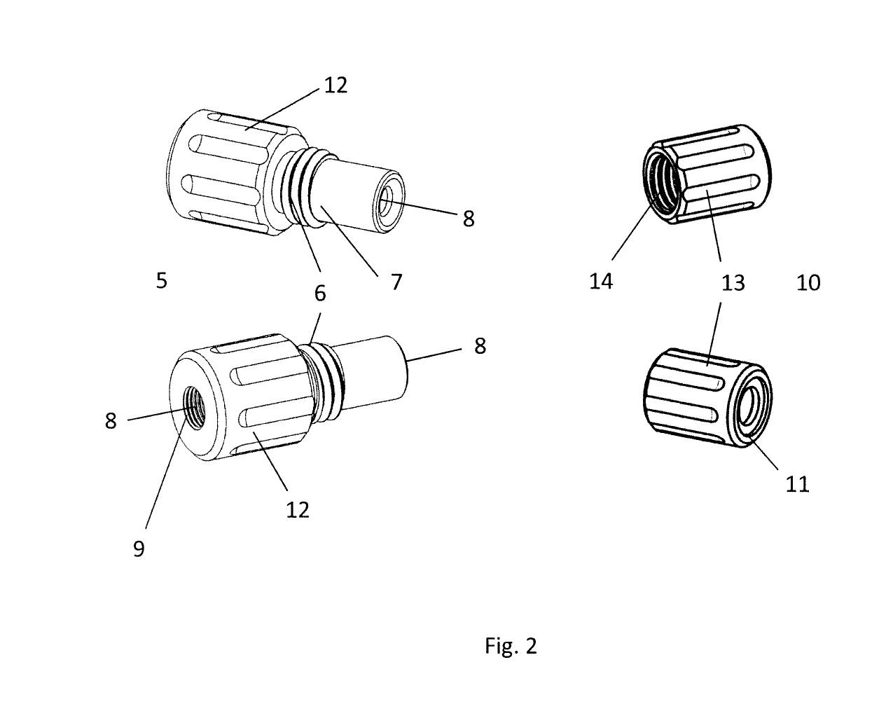

With reference to FIGS. 1 and 2, the quick connect coupling 2 is shown assembled in FIG. 1. FIG. 2 shows the coupling 2 disassembled into the body and body cap, with two views of each from differing angles. The quick connect coupling 2 is made up of a tubular body 5 with an air passage 8 therethrough, and tubular body cap 10, which body 5 and body cap 10 are threaded so as to fit together. The body 5 has a narrow portion 7 and a wider portion 12, which narrow portion 7 has threading 6, passes through the threaded inner diameter 14 of the body cap 10 and is coterminous with the end 11 of the body cap 10 when the body 5 and body cap 10 are screwed together as shown in FIG. 1. The wider portion 12 and the body cap 10 are knurled so as to facilitate being turned by hand relative to one another. The wide portion 12 has a threaded inner diameter 9 where the air passage 8 passes through. The end of this portion emerges from the body cap 10, and is threaded so as to engage with an air hose (not shown). With reference to FIG. 2, which shows each of the body 5 and body cap 10 from two different angles, the body 5 is generally a hollow cylinder having two different outside diameters, and the body cap 10 is a hollow cylinder also with a knurled outside diameter 13, having the same or similar diameter to the knurled portion 12 diameter. The body cap 10 has a threaded inside diameter 14, which fits over the body 5 and the threads engaging with threading 6, adjoining the body 5 and body cap 10 as shown in FIG. 1. Not shown here, the body cap 10 has a plunger 40 which fits therein and engages with the internal components of the body 5.

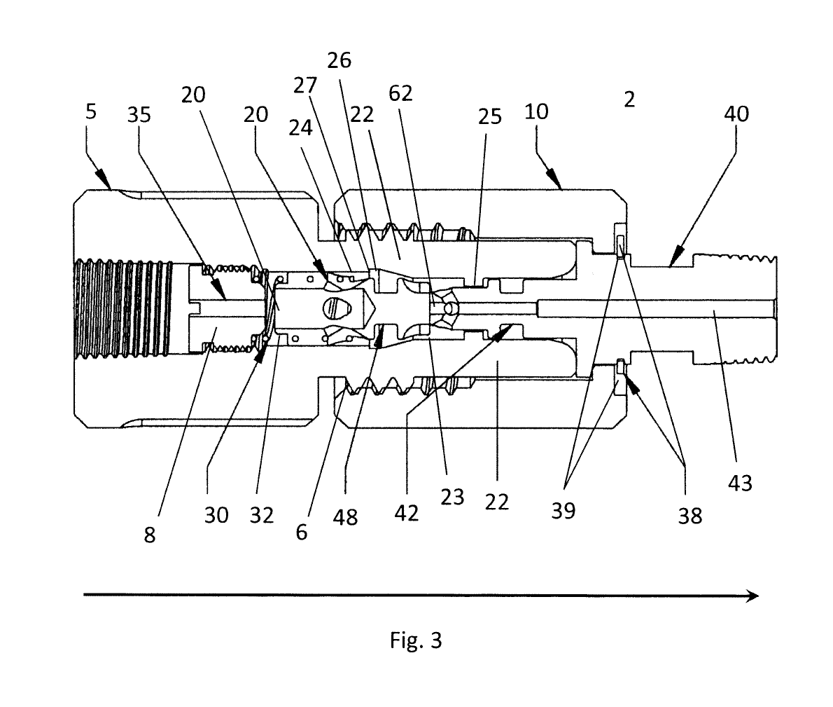

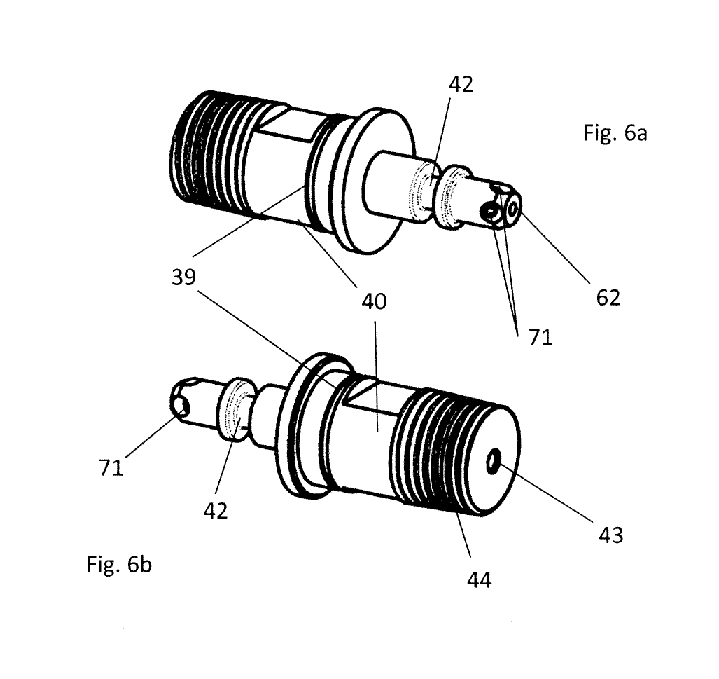

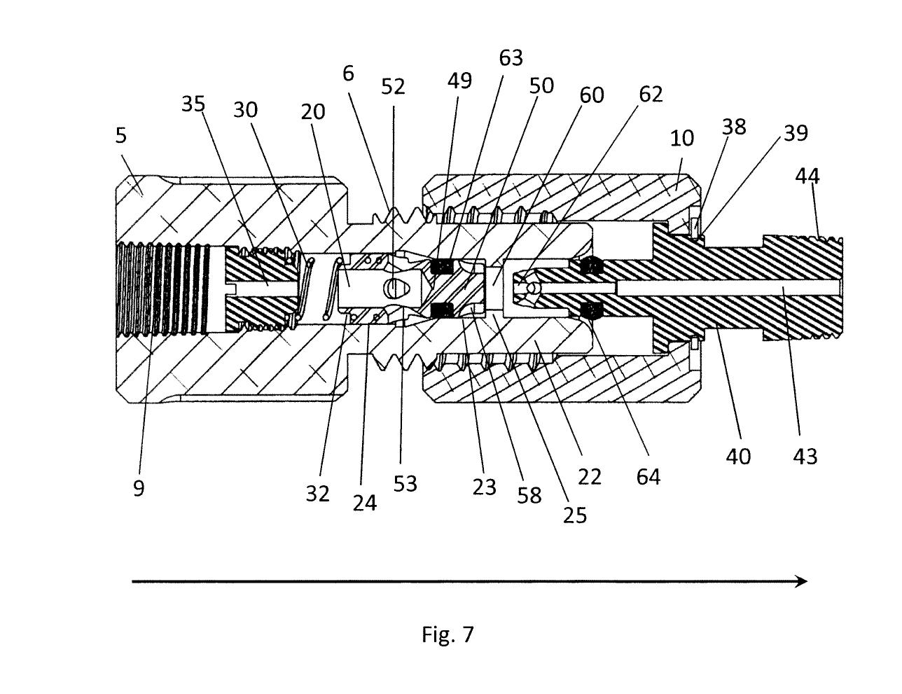

With reference to FIG. 3, the assembled coupling 2 is shown in a cut-away view showing the inner workings of the invention. As described above, the body cap 10 is turned on to the threading 6 of body 5. Within the body 5 is the air channel 8 running through the middle. The flow of air through the air channel 8 is managed by the poppet valve 20, which mounted between the walls 22 of the inner diameter of the body 5 that define the air channel 8. The arrow at the bottom of FIG. 3 shows the direction of air flow through the valve, defining an upstream position and a downstream position. The walls 22 taper from a dilation 24 upstream to a constriction 23 downstream, with an inside-circumferential recess 26 at the base of the taper, before a step 27 to the dilation 24. Within the constriction 23 is positioned a seat 25, which is a protrusion uniformly around the inner circumference of the constriction 23. The poppet 20 is movable from a downstream sealing position wherein it is in contact with the seat 25 to an upstream airflow position, such that there is an air space between the poppet 20 and the seat 25. The positions of the poppet 20 are further described below with reference to FIGS. 6-8. The poppet 20 is biased against the seat 25 by a spring 30 which pushes on the support 32 of the poppet 20, which spring 30 is mounted on a spring retainer 35. The plunger 40, which forms the internal component of the downstream fitting, is mounted within the body cap 10 by means of a retaining ring 38 which fits within the retaining groove 39 of the plunger 40, which retaining ring 38 holds the plunger 40 within the body cap 10 while allowing it to rotate relative to the plunger 40. The free rotation of the body cap 10 around the plunger 40 eases fastening the body 5 to the body cap 10 by means of threads 14. The plunger 40 is in a hollow cylinder form, and has an air channel 43 diametrically therethrough, and has an O-ring groove 42 adapted to hold an O-ring (not shown) and form a seal between the walls 22 and plunger 40. The poppet 20 has an O-ring groove 48 adapted to hold an O-ring (not shown), in order to seal between the walls 22 and the poppet 20, when the poppet is positioned within the constriction 23. The O-rings (shown in FIGS. 7-9) are well-known in the art and may be manufactured of rubber or plastic, for example.

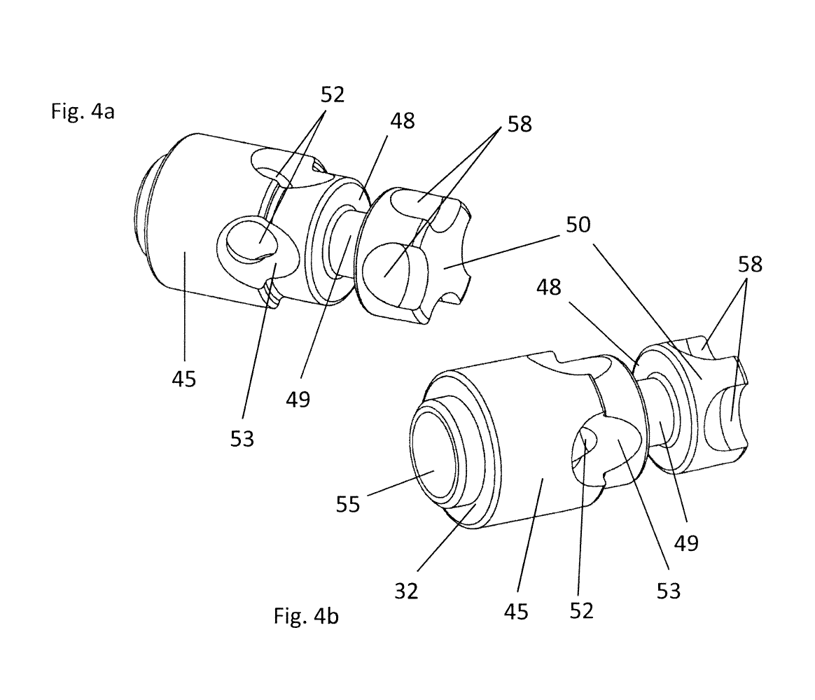

With reference to FIGS. 4a and 4b, the poppet valve 20 is shown from two angles. The poppet 20 consists of a poppet core 45, neck 49 and head 50. The core 45 is formed of a hollow cylinder shape, having an outlet 55 and four equidistantly-spaced apertures 52, each aperture 52 sitting within a depression 53 in the surface material of the core 45. The apertures 52 form a passage for fluid to pass from the surface of the core 45 through the interior of the core 45, which due to the hollow core 45, allows passage out the outlet 55. The head 50 has four equidistantly-spaced indentations 58, each in-line with the depressions 53 surrounding the apertures 52. The head 50 and core 45 are connected together as one piece by means of neck 49, which by its presence forms O-ring groove 48. The O-ring groove 48 in between the head 50 and core 45 holds a rubber O-ring (not shown) which interfaces with the constriction 23 to seal the air path.

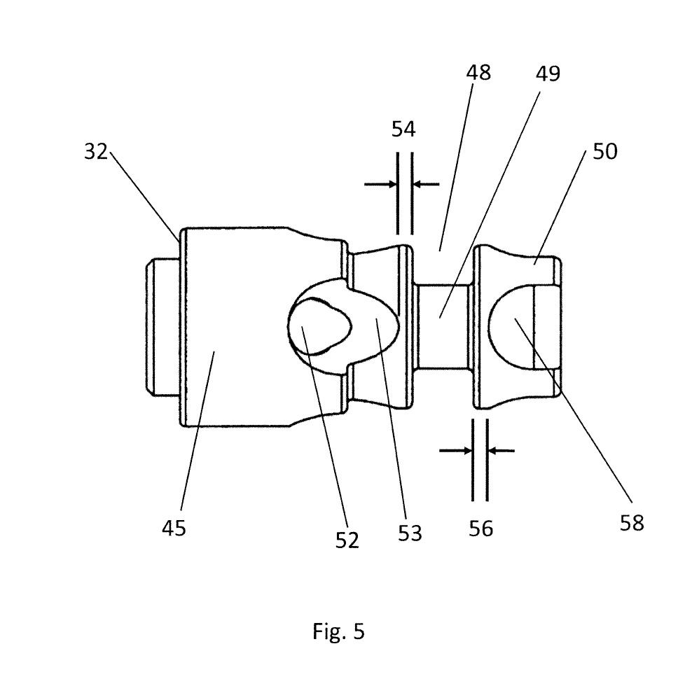

With reference to FIG. 5, the poppet 20 is shown from the side. The first set of arrows 54 show the preferred distance between the depression 53 and the edge of the O-ring groove 48, and second set of arrows 56 show the preferred distance between the indentations 58 and the edge of the O-ring groove 48; these distances are preferable so that the O-ring (not shown) which fills the groove 48 does not suffer premature wear.

With reference to FIGS. 6a and 6b, the plunger 40 is shown from two angles. The plunger 40 is a generally hollow cylindrical shape, with an air channel 43 therethrough. The plunger 40 has threading 44 at a wider end for engaging an air hose adapter (not shown). At the opposite end, a tip 62 is present which has four openings 71, which openings provide a passage to the air channel 43 and through the plunger 40.

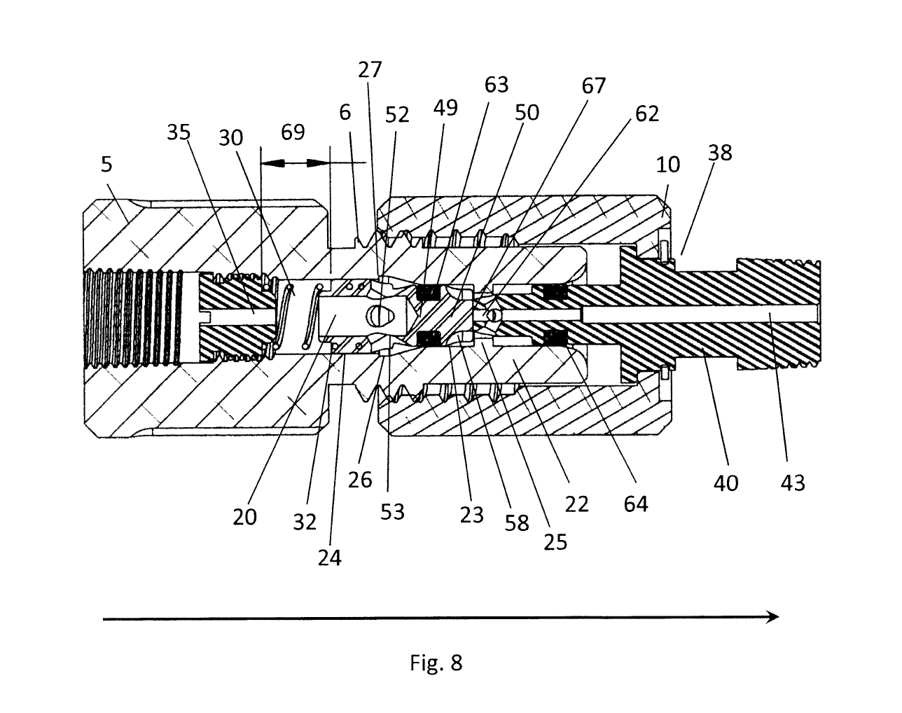

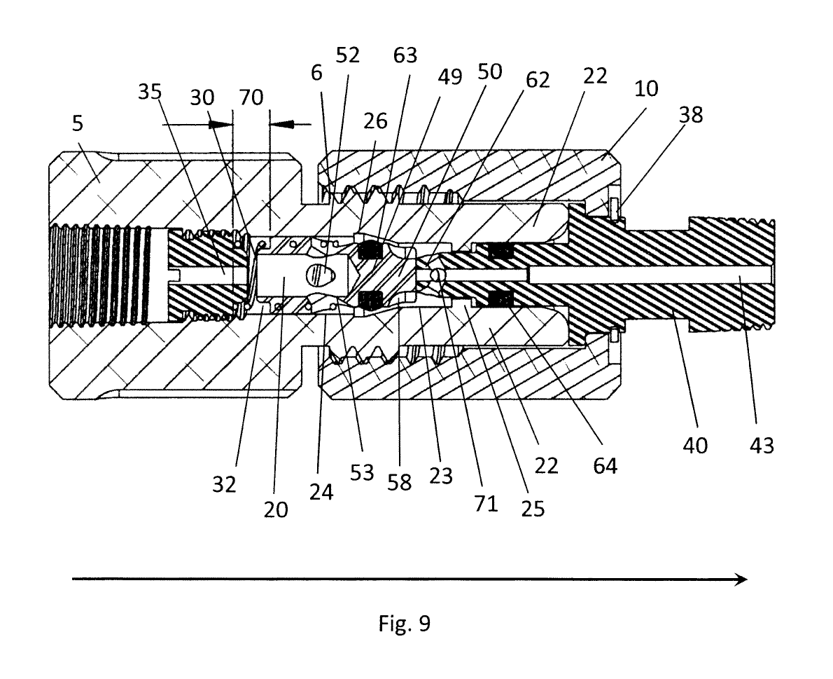

With reference to FIGS. 7, 8 and 9, the opening of the valve is shown as the body 5 and body cap 10 are fastened together. FIG. 7 shows the coupling pushed together, but the threading not yet started. FIG. 8 shows the coupling partially threaded, with the plunger 40 fully sealed and the poppet 20 not yet open. FIG. 9 shows the coupling fully mated, wherein the poppet 20 is fully open. With reference first to FIG. 7, the poppet 20 is positioned within the constriction 23 against the seat 25, to which position it is biased by the spring 30. The O-ring 63 that fills the O-ring groove 48 produces a seal with the walls 22 of the constriction 23, such that no air may pass. The recess 26 and step 27 receive air pressure while the valve is disconnected in a pressurized state, and consequently reduce the pressure on the O-ring. However, there is no seal yet between the O-ring 64 filling the O-ring groove 42 of the plunger 40, and the walls 22. As can be seen, there is a space 60 between the poppet 20 and the plunger 40, such that they do not contact one another.

With reference now to FIG. 8, as the coupling is partially threaded together, the plunger 40 and the spring-biased poppet 20 have made contact as they are pushed together. Specifically, the head 50 of the poppet touches on the tip 62 of the plunger 40, and an interface 67 replaces the space 60. While the O-ring 63 of the poppet 20 is still in contact with the walls 22 of the constriction 23 providing an airtight seal, the plunger 40 has entered the constriction 23 from the opposite end and the O-ring 64 is now also compressed against the walls 22 also forming an airtight seal. As shown by dimension 69, the spring is still in a fully-extended position, wherein the spring-biased poppet 20 rests against the seat 25.

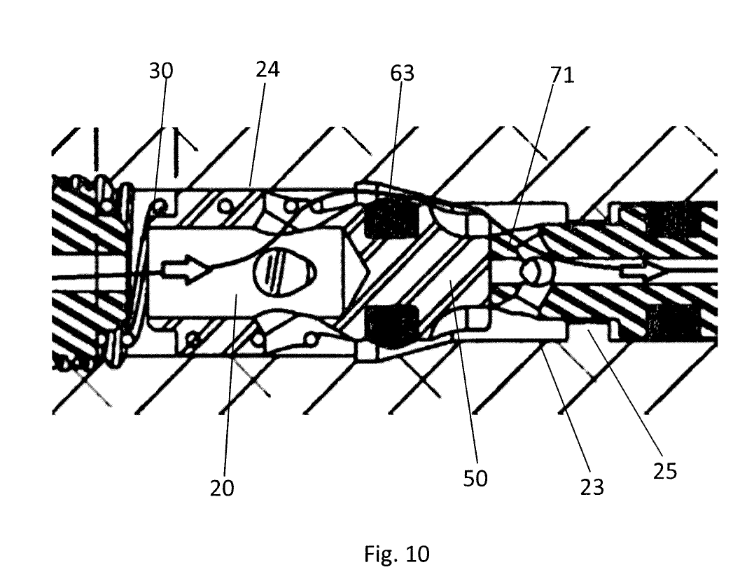

With reference to FIG. 9, as a result of the coupling fully threaded and mated together, the tip 62 of the plunger 40 pushes the poppet 20 back against the spring 30 such that the spring compresses, as shown by dimension 70. The O-ring 64 is compressed within the walls 23 still providing an airtight seal, however O-ring 63 of the poppet 20 has now retreated out of the constriction 23, and no longer seals within the dilation 24 as the diameter is too large. Furthermore, the head 50 is pushed away from the seat 25. This combination allows a passage of air to open between the openings 71 of the plunger 40 and apertures 52 of the poppet 20, shown more precisely by the line showing the airflow in FIG. 10.

The advantage to the poppet 20 design is the laminar and therefore efficient airflow that develops due to the four equidistantly-spaced apertures 52, each aperture 52 sitting within a depression 53 in the surface material of the core 45, as well as the equidistantly-spaced indentations 58 of the head 50, and the fact that each indentation 58 is in-line with the depressions 53 surrounding the apertures 52. The smooth airflow continues from the poppet 20 through the openings 71 of the plunger 40, the entire system being designed for reduced drag and higher resulting efficiency of the coupling. The advantage to the poppet 20 being positioned upstream the airflow, is that upon removal of the plunger, the airflow pressure will close the poppet 20 even if the spring 30 fails. The spring 30 acts as a guide for the poppet 20 to the seat 25. The described valve therefore enables connecting and disconnecting under pressure, is secure in its attachment and reduces accidental disconnection, permits a high flow of air through the line and valve.

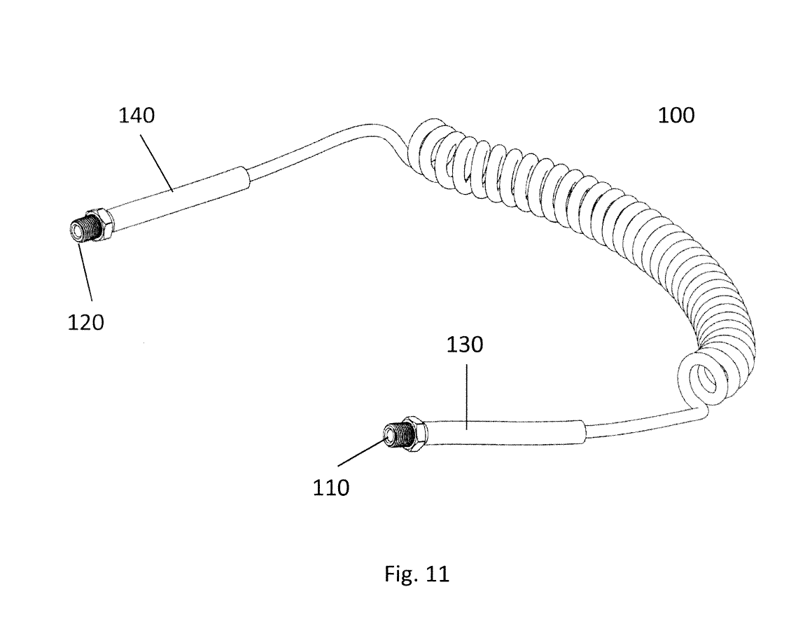

With reference to FIG. 11, an air hose 100 is shown as would be used in conjunction with the quick-connect coupler of the present invention. The first and second end 110 and 120 of the air hose 100 has identical ends. Each end 110 and 120 have a threaded end secured to the hose 100. The hose is secured to the threaded ends 110 and 120 by crimping the hose onto the threaded end and installing protective coverings 130 and 140. The air hose has an inner diameter of approximately 2 mm and an outer diameter of 5 mm. The use of an air hose with these physical features allows for an increase efficient of the air through the coupler and eventually through the paint ball gun not shown. The outer coil diameter of air hose 100 is 8.75 millimeter and the inner coil diameter is 5.75 millimeter. A small coil allows for ease of use by an individual using the coupler of the present invention connected to an air tank reservoir (not shown).

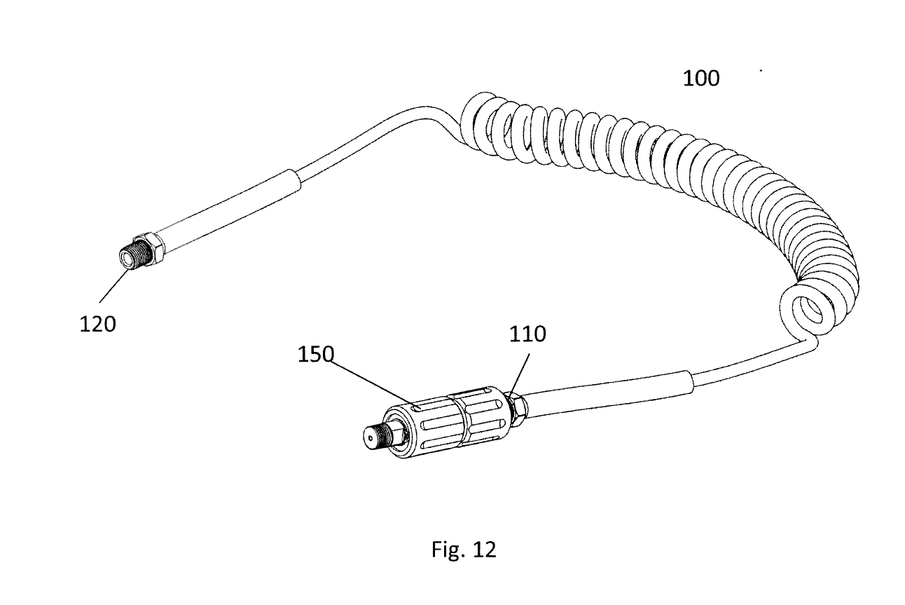

With reference to FIG. 12, the air hose 100 is shown with the coupler of the present invention attached to end 110. The coupler can be interchangeable attached to either end of air hose 100.

Although the invention has been described above by reference to certain embodiments of the invention, the invention is not limited to the embodiments described above. Modifications and variations of the embodiments described above will occur to those skilled in the art in light of the above teachings. Moreover, with respect to the above description, it is to be repulsed that the optimum dimensional relationships for the component members of the present invention may include variations in size, material, shape, form, funding and manner of operation.

Having thus described the invention, it is now claimed:

1. A quick connect coupler for the passage of pressurized fluids, comprising:
a. a body having threading, the body having an air passage therethrough;
b. a body cap having a threaded inner diameter;
c. a poppet movable from a downstream sealing position to an upstream airflow position, the poppet valve biased to the sealing position by a spring, the poppet valve having a core and a head, the core having at least one aperture therein for the passage of fluids from an upstream to a downstream direction and the head having at least one indentation corresponding in number and position with the at least one aperture; and
d. a plunger having a tip for contacting the head of said poppet
wherein the body and body cap are adapted to be sealingly threaded together, the poppet valve is positioned within the body and the plunger is positioned within the body cap.
